(19) United States
(12) Patent Application Publication
(10) Pub. No.: US 2024/0162673 A1
(43) Pub. Date: May 16, 2024

(54) CRIMPING PLIERS AND METHOD FOR ASSEMBLING CRIMPING PLIERS

(71) Applicant: WEZAG GmbH & Co. KG, Stadtallendorf (DE)

(72) Inventors: Thomas Glockseisen, Düsseldorf (DE); Gunthard Gebhard, Amöneburg (DE); Marco Ramosino, Stadtallendorf (DE)

(21) Appl. No.: 18/389,275

(22) Filed: Nov. 14, 2023

(30) Foreign Application Priority Data
Nov. 15, 2022 (EP) 22 207 540.0

(51) Int. Cl. H01R 43/042; B25B 27/14

(52) U.S. Cl. CPC H01R 43/042; B25B 27/143

(57) ABSTRACT

The invention relates to crimping pliers and a method of assembling crimping pliers. According to the invention, a coupling of a crimping pliers head (32) to a crimping pliers actuation assembly group (1) is provided by coupling recesses (45, 46) and coupling elements (22, 23) arranged in the coupling recesses (45, 46). A re-exit of the coupling elements (22, 23) from the coupling recesses (45, 46) is prevented by a spring device which is effective between the die halves (35, 37) for biasing the movable die half (37) in opening direction.

### CROSS REFERENCE TO RELATED APPLICATIONS

This application claims priority to co-pending European Patent Application No. EP 22 207 540.0 filed Nov. 15, 2022.

### FIELD OF THE INVENTION

The invention relates to crimping pliers, which are used for pressing or crimping (in the following “crimping”) a workpiece which can be a plug or connector with a cable arranged therein. By means of crimping pliers it is e.g. possible to produce a so-called “wire crimp” by crimping a contact region of the plug or connector to the electrical wire of the cable and/or to produce a so-called “insulation crimp” by crimping a clamping portion of the plug or connector to the insulating sheet of the cable. With respect to possible application fields of crimping pliers of this type reference is made to crimping pliers which are described and offered on the website www.wezag.de.

Furthermore, the invention relates to a method for assembling crimping pliers.

### BACKGROUND OF THE INVENTION

DE 100 56 900 C1 discloses crimping pliers comprising a crimping pliers actuation assembly group and a crimping pliers head. The crimping pliers actuation assembly group has two hand levers that are pivotally connected to each other via a pivot bolt. A pulling bar is hinged to each of the hand levers at a distance from the pivot bolt. The crimping pliers actuation assembly group has a forced locking mechanism, by means of which a partially closed position of the hand levers, once reached during a crimping stroke, is secured in a ratchet-like manner and an opening movement of the hand levers is only made possible at the end of the crimping stroke. The crimping pliers head has a pliers head frame to which a fixed die half is fixed and on which a movable die half is guided for displacement in the direction of a crimping axis. The movable die half is supported by a spring device on the die head frame in such a way that the spring device biases the die half in an opening direction. The pliers head frame has frame plates extending parallel to one another, between which the fixed die half is held and the movable die half is guided. For assembling the crimping pliers actuation assembly group to the crimping pliers head, the movable die half has a U-shaped pivot bolt accommodation which is open on one side in the direction of the pivot bolt of the crimping pliers actuation assembly group. Furthermore, the pliers head frame has pulling bar coupling devices that have through bores of the frame plates oriented vertically to the pliers head plane. The pulling bars each have a through bore oriented vertically to the pliers head plane in the end region facing away from the linkage to the hand levers. For assembly, the crimping pliers actuation assembly group is approached to the crimping pliers head in such a way that the pivot bolt, which pivotally couples the hand levers to each other, enters the pivot bolt accommodation. At the same time, the pulling bars are pivoted between the frame plates so that the bores in the frame plates are aligned with the bores in the pulling bars. Coupling bolts or rivets are then inserted into the aligned bores. In the assembled state, the crimping pliers head with the frame plates and the pulling bars arranged therein is trapped between heads of the coupling bolts and a latching ball of the coupling bolt.

### SUMMARY OF THE INVENTION

The invention relates to a crimping pliers which comprise two hand levers which are pivotably connected to one another via a pivot bolt. Two pulling bars are hinged to the hand levers at a distance from the pivot bolt. The crimping pliers have a crimping pliers head. The crimping pliers head comprises a pliers head frame, a spring device and a die half. This die half is guided displaceably in the direction of a crimping axis on the pliers head frame. The spring device supports the die half on the pliers head frame in such a way that the spring device biases the die half in an opening direction. The spring device can thus cause the die halves (and thus possibly also the hand levers) to open automatically at the end of a crimping stroke. The die half has a pivot bolt accommodation that is open on one side.

Embodiments of the proposed crimping pliers can be improved in terms of
the manufacturing and/or
the assembly and/or
the disassembly and/or
the use of a crimping pliers actuation assembly group with different crimping pliers heads.

Furthermore, embodiments proposed relate to an improved method for the assembly of crimping pliers.

In the crimping pliers, at least one pulling bar is pivotably connected to the pliers head frame via a coupling device. To simplify the description, it is assumed in the following that both pulling bars are each pivotably connected to the pliers head frame via a coupling device (without this necessarily being the case).

In the assembled state of the crimping pliers, the pivot bolt is arranged in the pivot bolt accommodation. Due to the explained type of pivot connections and the kinematics caused in this way, a pivoting of the hand levers causes a movement of the movable die half relative to the pliers head frame, so that, for example, with a pivoting of the hand levers in the closing direction the crimping stroke with a closing of the two die halves can be caused.

It is proposed that (in deviation from the prior art mentioned at the beginning) no holes with an edge-closed cross-section are used as coupling recesses for coupling the pulling bars to the pliers head frame which require the coupling bolts to be inserted vertically to the pliers head plane. Rather, coupling devices for coupling the pulling bars to the pliers head frame are used, each comprising a coupling recess being open on one side and a coupling element. The coupling between the coupling recess and the coupling element (and thus also the coupling between the pulling bars and the pliers head frame) can be brought about by means of a relative pivoting of the coupling recess and the coupling element in the direction of the pliers head plane. In particular, this coupling does not require the insertion of a coupling bolt vertical to the pliers head plane as being required for the prior art mentioned at the beginning. Rather, the coupling can be brought about and released again in a particularly simple manner by bringing about the relative pivoting required for the coupling. With the relative pivoting the coupling element enters via the edge opening into the coupling recess. Here, entry takes place with a movement in the pliers head plane (or parallel thereto) and on a circular path around the pivot bearing which links the pulling bars to the associated hand lever.

At the same time, one embodiment takes into account the need to prevent the coupling from being released unintentionally during the use of the crimping pliers. This can be provided by the fact that the spring device which is responsible for biasing the movable die half in the opening direction secures the coupling between the coupling recess and the coupling element. This means that the spring device generates a spring force that holds the coupling element in the coupling position in the coupling recess. In order to release the coupling, it is therefore not only required to pivot the coupling element out of the coupling recess, but this bias by the spring device also has to be overcome.

It is possible that additional coupling measures are taken after such a coupling and securing of the coupling. However, preferably the reliable coupling is ensured exclusively by the explained interaction between the coupling recesses and the coupling elements and the securing by the spring device.

For another proposal the coupling recesses are formed and their openings are oriented in such a way that these define entry directions of the coupling elements into the coupling recesses, which are inclined at an acute angle with respect to the crimping axis. For example, the coupling recesses can be formed as outwardly open elongated holes or as U-shaped accommodations. Here, the side legs of the U can also diverge as desired and/or be of straight-line or curved design. The inclination of the coupling recesses at the acute angle has the effect that, on the one hand, the spring device generates a biasing force component which is dependent on the acute angle and which endeavors to push or pull the respective coupling element into the coupling recess and towards the bottom of the coupling recess. On the other hand, the acute angle has the consequence that the coupling elements cannot be moved transversely to the crimping axis, but collide with the limitation of the coupling recess, thus ensuring protection against unwanted exit of the coupling element from the coupling recess.

In the following, two different variants for the design of the crimping pliers are explained (without a limiting of the invention to these variants being intended):
a) For a first variant, the coupling recesses are formed by the pliers head frame. For example, the coupling recesses can be formed in the end region facing towards the crimp pliers actuation assembly group and at a location laterally outside from the pliers head frame. In this case, the longitudinal axis of the coupling recesses preferably extends in the pliers head plane. On the other hand, in this case the coupling elements are coupling bolts, coupling pins or coupling protrusions of the pulling bars. These are arranged in the end regions of the pulling bars facing away from the linkage on the hand levers and extend vertically to the pliers head plane.
   It is possible for this first variant that the pliers head frame comprises two frame plates extending parallel to each other. Here, the pliers head frame can basically correspond to the prior art introduced at the beginning in this respect and with regard to the accommodation and guidance of the die halves. In this case, however, the two frame plates each have a coupling part recess which together form the coupling recess. In this respect, the pliers head frame thus differs from the pliers head frame according to DE 100 56 900 C1.
   A pulling bar may have a base body and aligned coupling bolts, coupling pins or coupling protrusions arranged on both sides of the base body, which extend vertically to the pliers head plane. Here, the base body on the one hand and the coupling bolts, coupling pins or coupling protrusions on the other hand can be formed by an integral, one-piece component, or these can be formed as separate components and be firmly connected to one another in the pulling bar. For this embodiment, the base body in the pivoted-in state extends into the interspace between the frame plates, while then in the assembled state the coupling bolts, coupling pins or coupling protrusions are arranged in the coupling part recesses.
   If the base body and the coupling bolts, coupling pins or coupling protrusions form one-piece pulling bars, these can be produced, for example, in a MIM manufacturing process.
   A further improved interaction between the pulling bars and the pliers head frame may result if, for another proposal, the coupling bolts, coupling pins or coupling protrusions have a protrusion in the end region facing away from the main body. In this case, the frame plates can each be trapped between this protrusion and the base body. Thus, for assembly and disassembly the pivoting insertion of the coupling bolts, coupling pins or coupling protrusions into the coupling recess is possible, while vertically to the pliers head plane protection against undesired movements can be ensured by the fact that the frame plates are trapped between a protrusion and the base body.
b) For a second variant of the crimping pliers, the pulling bars comprise the coupling recesses. In this case, the coupling elements are formed as coupling bolts, coupling pins or coupling protrusions, which are formed by the pliers head frame or are supported by the pliers head frame. If for the assembly the pulling bars are pivoted into the assembly position, the coupling bolts, coupling pins or coupling protrusions of the pliers head frame enter into the coupling recesses of the pulling bars. In this way a coupling secured by means of the spring device can take place, as previously explained.
   Also for the second variant the pliers head frame can have two frame plates extending parallel to each other which can then be connected to each other via a coupling bolt. In this case, the coupling bolt that connects the frame plates to one other can also be used multifunctionally: The pulling bar has a base body that forms the coupling recesses and extends in the intermediate space between the frame plates. The coupling bolt connecting the frame plates is then arranged in the coupling recesses.

In principle, it is possible that in the assembled position the pulling bars extend inside the pliers head so that they can be covered by the pliers head frame or the frame plates when viewed vertically to the pliers head plane (which can apply for selected operating positions of the crimping pliers, a partial crimping stroke or during the entire crimping stroke. For one proposal, actuating elements are provided on the pulling bars which protrude laterally from the pliers head frames (permanently, for a partial crimping stroke and in particular in the open position). The actuating elements may be, for example, wings, extensions, gripping surfaces and the like. Via these actuating elements, forces can be applied manually to the pulling bars, which can then pivot the pulling bars into the assembled position or also pivot the pulling bars for disassembly.

Another proposal addresses the need that for mounting the crimping pliers actuation assembly group to the crimping pliers head and enabling the entry of the coupling elements into the coupling recesses it is necessary for the user to move the movable die half in the closing direction against the bias by the spring device. The simultaneous effectuation of relative movements between the coupling elements and the coupling recesses, on the one hand, and the effectuation of the movement of the movable die half in the closing direction, on the other hand, can place increased demands on the operator. This is remedied by an embodiment wherein the pulling bars and the movable die half have contact surfaces which come into contact with each other during assembly. The contact surfaces are oriented in such a way that assembly forces applied to the pulling bars are converted into a force component, which results in an increase in the bias of the spring device and a movement of the movable die half in the closing direction. Thus, if an operator pivots the pulling bars to bring about the coupling and the operator biases the pulling bars with an assembly force oriented toward the coupling position, a force component of the assembly force is used to actually bring about entry of the coupling element into the coupling recess. Another force component ensures the movement of the movable die half in the closing direction which is required for this entry of the coupling element into the coupling recess. In this way, handling during assembly can be significantly simplified.

Proposed is also a method for the assembly of a crimping pliers of the type described above. In this method, the pivot bolt is inserted into the pivot bolt accommodation of the die half. Simultaneously or subsequently, the pulling bars are connected to the crimping pliers head by inserting the coupling elements into the coupling recesses while simultaneously compressing the spring device in such a way that the coupling elements are secured against re-exiting from the coupling recesses as a result of the bias by the spring device.

Here, it is possible that the entry of the coupling elements into the coupling recesses is effected by manual actuation of the actuating elements described above, which protrude laterally from the pliers head frame, and/or that the movement of the movable die half in the closing direction which is required for the entry is effected via the contact surfaces between the pull tabs and the movable die half as described above.

Advantageous further embodiments of the invention result from the patent claims, the description and the drawings.

The advantages of features and of combinations of several features mentioned in the description are merely exemplary and can be affected alternatively or cumulatively, without the advantages necessarily having to be achieved by embodiments according to the invention.

With regard to the disclosure—not the scope of protection—of the original application documents and the patent, the following applies: Further features can be taken from the drawings— in particular the geometries shown and the relative dimensions of several components to each other as well as their relative arrangement and effective connection. The combination of features of different embodiments of the invention or of features of different patent claims is also possible in deviation from the selected referrals of the patent claims and is hereby suggested. This also applies to such features which are shown in separate drawings or are mentioned in the description thereof. These features can also be combined with features of different patent claims. Likewise, features listed in the patent claims may be omitted for further embodiments of the invention, which does not apply to the independent patent claims of the granted patent.

The features mentioned in the patent claims and the description are to be understood with respect to their number in such a way that exactly this number or a larger number than the number mentioned is present, without requiring an explicit use of the adverb “at least”. Thus, for example, when one element is mentioned, this is to be understood as meaning that exactly one element, two elements or more elements are present. The features listed in the patent claims may be supplemented by further features or may be the only features that the subject matter of the respective patent claim has.

The reference signs contained in the patent claims do not represent a limitation of the scope of protected by the patent claims. They merely serve the purpose of making the patent claims easier to understand.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

In the following, the invention is further explained and described with reference to preferred embodiments shown in the figures.

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 shows an exploded view of a crimping pliers actuation assembly group of crimping pliers.

FIG. 2 shows a three-dimensional representation of the crimping pliers actuation assembly group of crimping pliers according to FIG. 1 in an assembled state.

FIG. 3 shows an exploded view of a crimping pliers head of crimping pliers that can be used together with a crimping pliers actuation assembly group according to FIGS. 1 and 2.

FIG. 4 shows a three-dimensional representation of the crimping pliers head of crimping pliers according to FIG. 3 in an assembled state.

FIGS. 5 to 8 show in three-dimensional representations an assembly and operation of crimping pliers with a crimping pliers actuation assembly group according to FIGS. 1 and 2 and a crimping pliers head according to FIGS. 3 and 4.

FIG. 9 shows a partially assembled state of crimping pliers according to FIGS. 5 to 8 in a top view on the pliers head plane.

FIG. 10 shows a sectional view of the crimping pliers according to FIGS. 5 to 9 cut parallel to the pliers head plane.

FIG. 11 shows the crimping pliers according to FIGS. 5 to 10 in a closed position in a top view on the pliers head plane.

FIG. 12 shows the crimping pliers according to FIGS. 5 to 11 in the closed position in sectional view cut parallel to the pliers head plane.

FIG. 13 shows a three-dimensional representation of a pulling bar as it can be used in a crimping pliers actuation assembly group according to FIGS. 1 and 2 and crimping pliers according to FIGS. 5 to 12.

FIG. 14 shows an exploded view of another embodiment of a crimping pliers actuation assembly group.

FIG. 15 shows a three-dimensional representation of the assembled crimping pliers actuation assembly group of FIG. 14.

FIG. 16 shows an exploded view of a crimping pliers head that can be used together with a crimping pliers actuation assembly group according to FIGS. 14 and 15.

FIG. 17 shows the crimping pliers head according to FIG. 16 in assembled condition in a three-dimensional representation.

FIGS. 18 to 21 show crimping pliers, which have a crimping pliers actuation assembly group according to FIGS. 14 and 15 and a crimping pliers head according to FIGS. 16 and 17, in different assembly and operating states in a top view on the pliers head plane, partially in a cut state with sectional guidance parallel to the pliers head plane.

FIGS. 22 to 23 in three-dimensional representations show different possible configurations of pulling bars of a crimping pliers actuation assembly group according to FIGS. 14 and 15 and of crimping pliers according to FIGS. 18 to 21.

### DETAILED DESCRIPTION

In the following description, components or features which correspond to each other or are similar in terms of design, geometry and/or function are partially labelled with the same reference numbers, in which case they may be distinguished from one another by means of a supplementary letter a, b, . . . , In this case, the components or features can be referred to with or without the supplementary letter, whereby without using the supplementary letter then one component or feature, several components or features or all components or features can be addressed.

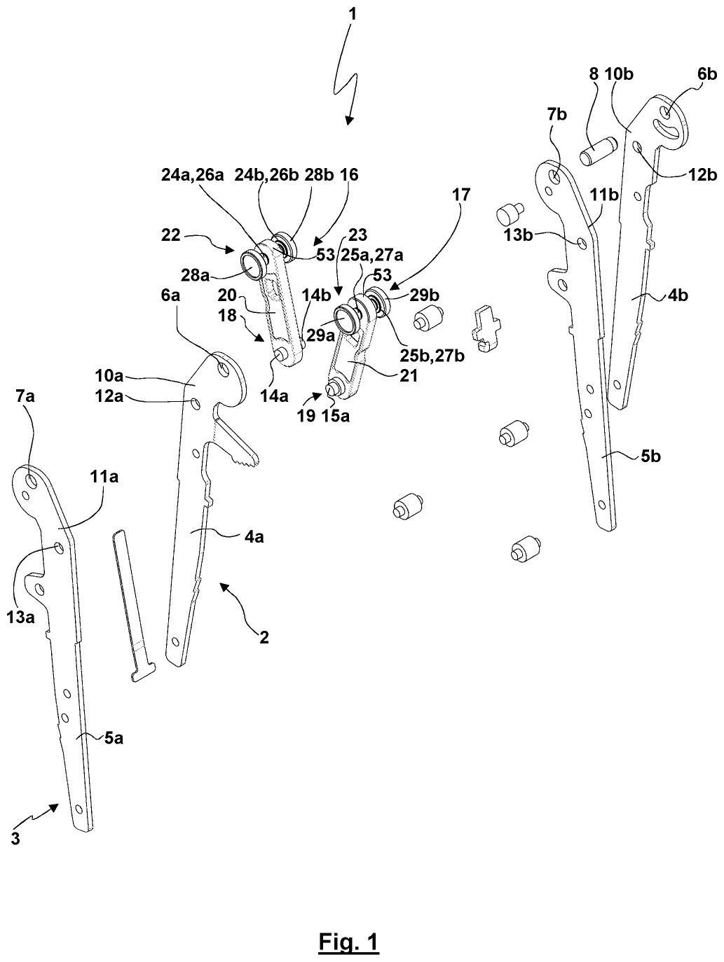

FIG. 1 shows a crimping pliers actuation assembly group 1. The crimping pliers actuation assembly group 1 has hand levers 2, 3. The hand lever 2 is formed with two hand lever plates 4a, 4b. Correspondingly, the hand lever 3 is formed with two hand lever plates 5a, 5b.

In the end region facing away from the grip part of the hand levers 2, 3, the hand levers 2, 3 each have a bore 6, 7, which are formed here as bores 6a, 6b of the hand lever plates 4a, 4b and as bores 7a, 7b of the hand lever plates 5a, 5b.

The bores 6, 7 form bearing eyes through which a pivot bolt 8 extends. In this way a pivot bearing 9 is formed. By the pivot bearing 9, the hand levers 2, 3 are pivotably connected to each other so that they can perform an opening and closing movement for causing a crimping stroke and an opening stroke.

The hand levers 2, 3 are preferably slightly angled relative to one another with angular sections 10, 11. In the region of the angled sections 10, 11, the hand levers 2, 3 have bores 12, 13. In these bores 12, 13 pivot pins 14, 15 of pulling bars 16, 17 are accommodated. In this way pivot bearings 18, 19 are formed, by which the pulling bars 16, 17 linked for being pivoted to the hand levers 2, 3. For the illustrated embodiment, the pulling bars 16, 17 each have pivot pins 14a, 14b and pivot pins 15a, 15b on both sides of a base body 20, 21, respectively, which are received in bores 12a, 12b and bores 13a, 13b of the hand lever plates 4a, 4b and 5a, 5b, respectively.

The pulling bars 16, 17 are rectilinear and of strut or rod-like design. In the end regions facing away from the pivot pins 14, 15, the pulling bars 16, 17 each have a coupling element 22, 23. On both sides of their base bodies 20, 21, the coupling elements 22, 23 have coupling element parts 24a, 24b and 25a, 25b, respectively, which are designed here as coupling pins 26a, 26b and 27a, 27b, respectively, and have extensions 28a, 28b, 29a, 29b in the end regions facing away from the base body 20, 21.

For the embodiment shown in FIG. 1, the pulling bars 16, 17 are integrally formed or monolithic so that the base bodies 20, 21, the pivot pins 14, 15 and the coupling elements 22, 23 are integral parts of a single structural component.

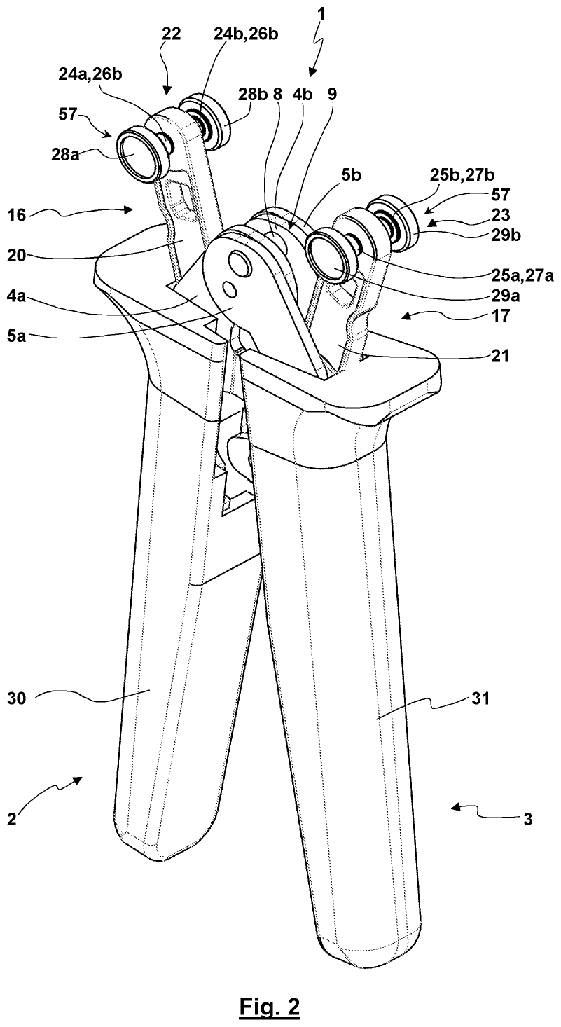

FIG. 2 shows the crimping pliers actuation assembly group 1 in the assembled state. Here, elastomeric handles 30, 31 are additionally pushed onto the hand levers 2, 3. It can be seen here that the pulling bars 16, 17 with the coupling elements 22, 33 protrude freely upwards from the crimping pliers actuation assembly group 1. The pulling bars 16, 17 can be pivoted freely as a result of the linkage via the pivot bearings 18, 19 to the hand levers 2, 3. Furthermore, the pivot bolt 8 is freely accessible from above between the hand lever plates 4, 5.

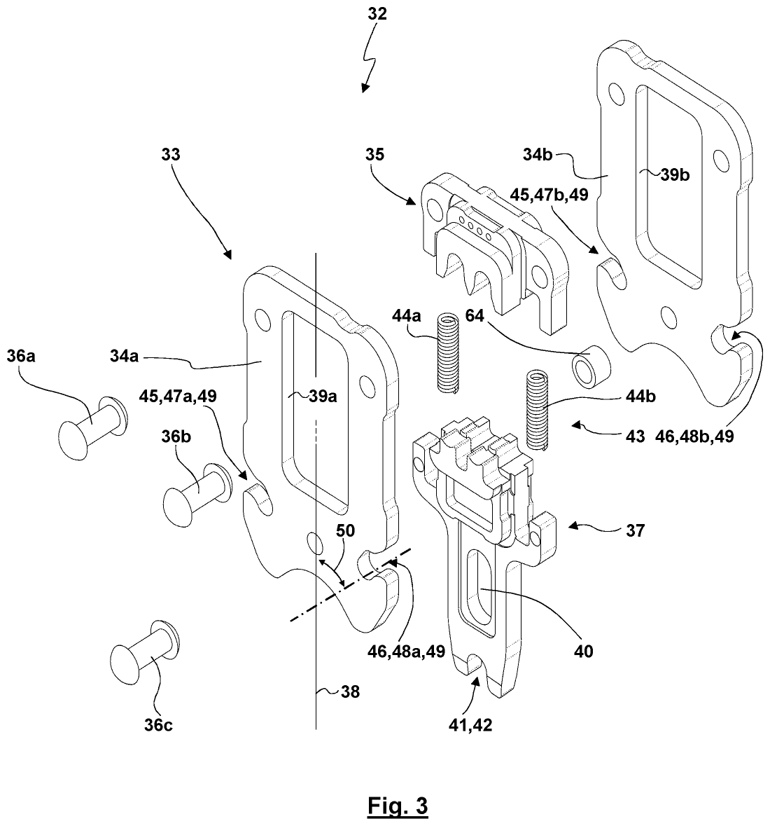

FIG. 3 shows a three-dimensional exploded view of a crimping pliers head 32. The crimping pliers head 32 has a pliers head frame 33, which here comprises frame plates 34a, 34b. A fixed die half 35 is arranged between the frame plates 34a, 34b. Connecting elements, in particular rivets 36a, 36b, connect the frame plates 34a, 34b and the fixed die half 35 arranged between them to form a fixed structural unit. The two frame plates 34a, 34b are further connected by a further rivet 36c.

The plier head 32 further has a movable die half 37. The movable die half is guided for being displaced on the plier head frame 33 in the direction of a crimping axis 38, which can be done, for example, by the frame plates 34a, 34b having recesses 39a, 39b that form lateral guide surfaces on which guide surfaces of the movable die half 37 are guided. The rivet 36c can extend together with the sleeve 64 through a recess 40 of the movable die half 37 and provide additional guidance and/or a limitation of the movement of the movable die half 37.

In the end region facing away from the fixed die half 35, the movable die half 37 has a pivot bolt accommodation 41. In the embodiment shown, the pivot bolt accommodation 41 is designed as an U-shaped recess 42, which has an open-edged cross section. The pivot bolt accommodation 41, in this case the recess 42, is open downwards, i.e. in the state mounted on the crimping pliers actuation assembly group 1 in the direction of the crimping pliers actuation assembly group 1.

The crimping pliers head 32 comprises a spring device 43, which is formed here with two springs 44a, 44b. The springs 44 are designed as compression springs. One spring base of the springs 44 is supported on the pliers head frame 33 and/or the fixed die half 35, while the other spring base of the springs 44 is supported on the movable die half 37. In the open position, in which the die half 37 has the maximum distance from the die half 35, the bias of the spring device 43 is minimal, while the bias of the spring device 43 increases as the die half 34 approaches the die half 35 over the crimping stroke. For the illustrated embodiment, the springs 44 are symmetrically arranged on both sides adjacent die surfaces of the die halves 35, 37 between which the workpiece is crimped.

The pliers head frame 33 has coupling recesses 45, 46. Here, the frame plates 34a, 34b form coupling recess parts 47a, 47b of the coupling recess 45 and coupling recess parts 48a, 48b of the coupling recess 46.

For the embodiment shown, the coupling recesses 45, 46 and the coupling recess parts 47, 48 are formed as elongated holes 49 open on one side in the outer end region. In this case, the elongated holes 49 are inclined at an acute angle 50 with respect to the crimping axis 38, the angle 50 preferably being in the range of 20-80° or 30 to 60° or 35 to 55°. Here, the acute angle 50 is oriented such that the apex points towards the crimping pliers actuation assembly group 1, so that an entry movement from the outside into the elongated hole 49 has a component oriented towards the pivot bolt accommodation 41 and the crimping pliers actuation assembly group 1. The elongated hole 49 may have non-parallel lateral boundaries that have any curvilinear shape when projected onto the pliers head plane.

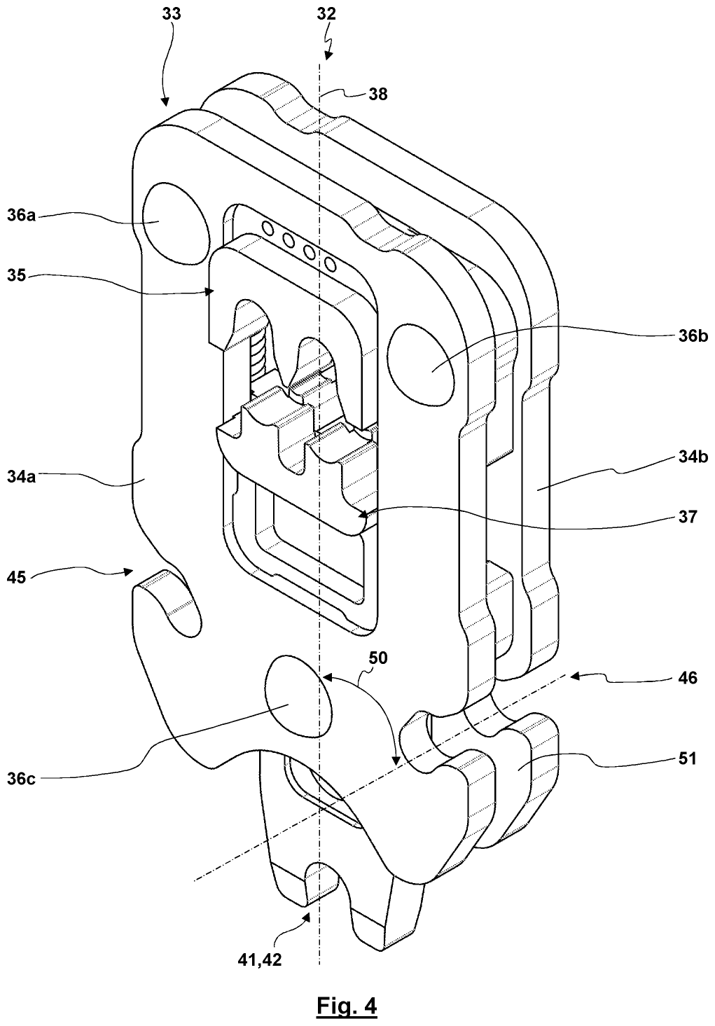

As a result of the distance between the frame plates 34, there is a gap 51 between the frame plates 34 (cp. FIG. 4). This gap 51 also exists between the pairs of coupling recess parts 47a, 47b and coupling recess parts 48a, 48b. In the area of the rivets 36a, 36b, the gap 51 between the frame plates 34 is defined by the die half 35. Instead, the rivet 36c is surrounded by a sleeve 94, which defines the distance between the frame plates 34 in the area of the rivet 36c.

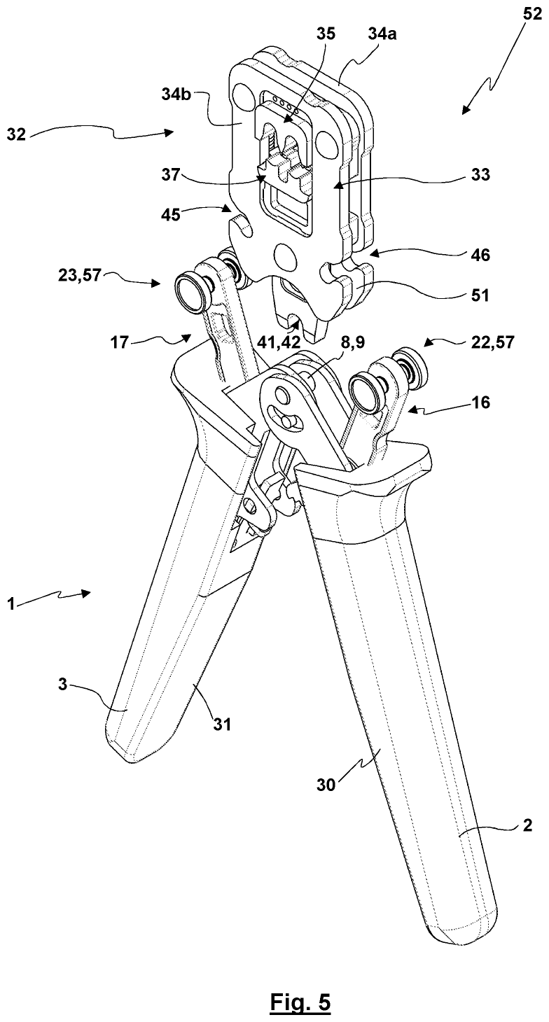

FIG. 5 shows the crimping pliers actuation assembly group 1 and the crimping pliers head 32 before assembly.

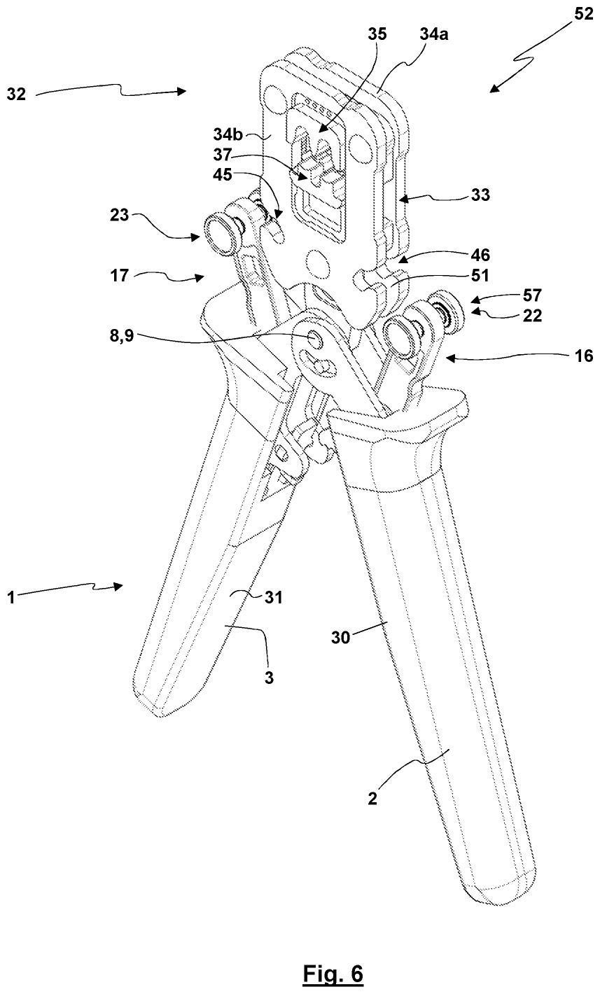

Referring to FIG. 6, for assembly, the crimping pliers actuation assembly group 1 is approached to the crimping pliers head 32 from below such that the pivot bolt 8 enters the pivot bolt accommodation 41 from below. By bringing the pivot bolt 8 into contact with the bottom of the pivot bolt accommodation 41, an actuating force can be transferred between the crimping pliers actuation assembly group 1 and the crimping pliers head 32, which strives to push the movable die half 37 upward. However, in the partially assembled state shown in FIG. 6, the pulling bars 16, 17 are still in a pivoted position in which they are laterally of the pliers head frame 33 without being coupled.

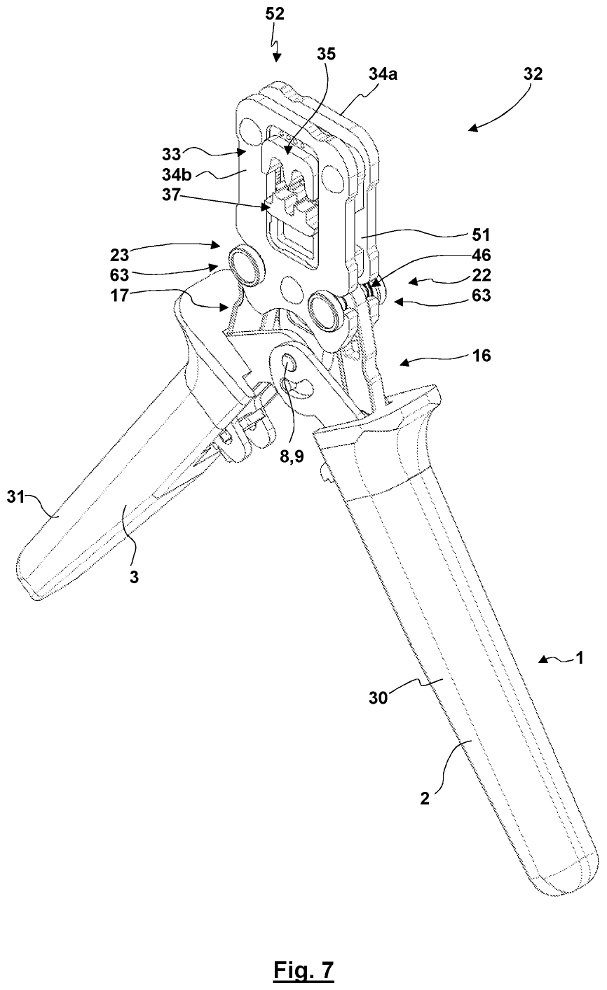

For further assembly, as shown in FIG. 7, the pulling bars 16, 17 are pivoted inward towards each other and towards the pliers head frame 33 until the coupling elements 22, 23 of the pulling bars 16, 17 enter the coupling recesses 45, 46 of the pliers head frame 33. In the present case, the coupling pins 26a, 26b enter the coupling recess parts 47a, 47b of the frame plates 34a, 34b and the coupling pins 27a, 27b of the pulling bar 17 enter the coupling recess parts 48a, 48b of the pliers head frame 33. At the same time, the base bodies 20, 21 of the pulling bars 16, 17 enter the intermediate space 51 formed between the frame plates 34a, 34b.

The length of the pulling bars 16, 17 is dimensioned such that the explained entry of the coupling elements 22, 23 into the coupling recesses 45, 46 can only occur when a movement of the movable die half 37 in the closing direction occurs. This movement is greatest when the coupling elements 22, 23 enter straight into the openings of the coupling recesses 45, 46, while a return movement of the movable die half 37 in the opening direction can occur when the coupling elements 22, 23 move into the interior of the coupling recesses 45, 46 to the bottom thereof. The partial closing movement required for the entry of the coupling elements 22, 23 into the coupling recesses 45, 46 is smaller than the crimping stroke and is, for example, less than 20%, less than 15% or less than 10% of the crimping stroke. At the end of the entry movement, when the coupling elements 22, 23 rest against the bottom of the coupling recesses 45, 46, the movable die half 37 can again reach the initial position, i.e. the maximum open position. Preferably, however, a partial closing stroke then remains, which may be, for example, less than 10% or less than 5% of the crimping stroke. The explained partial closing movement and the described partial closing positions are accompanied by a loading of the spring device 43. The spring force of the spring device 43 causes the coupling elements 22, 23 to be drawn into the coupling recesses 45, 46 and to be pressed with a spring force component against the bottom of the coupling recess 45, 46. Disassembly with the coupling elements 22, 23 being moved out of the coupling recesses 45, 46 thus requires overcoming this spring force component, which is generated by the spring device 43. In the assembled state the extensions 28a, 28b, 29a, 29b of the pulling bars 16, 17 avoid or reduce an undesired elastic opening displacement of the frame plates 34a, 34b due to forces which are effective during the crimping stroke.

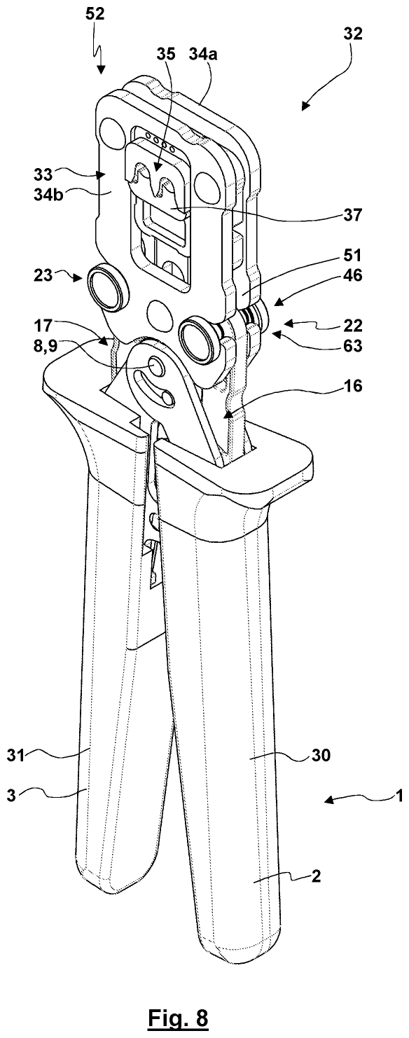

When crimping pliers 52 formed by assembling the plier actuation assembly group 1 and the plier head 32 as shown in FIG. 7 is used to crimp or press a workpiece, the operator closes the hand levers 2, 3, causing a passing of the crimping stroke. FIG. 8 shows the crimping pliers 52 at the end of the crimping stroke, at which the hand levers 2, 3 and the die halves 35, 37 are closed.

In FIGS. 7 and 8, it can be seen that in the assembled state in a direction vertical to the pliers head plane the frame plates 34a, 34b are each trapped between the base bodies 20, 21 and an extension 28, 29.

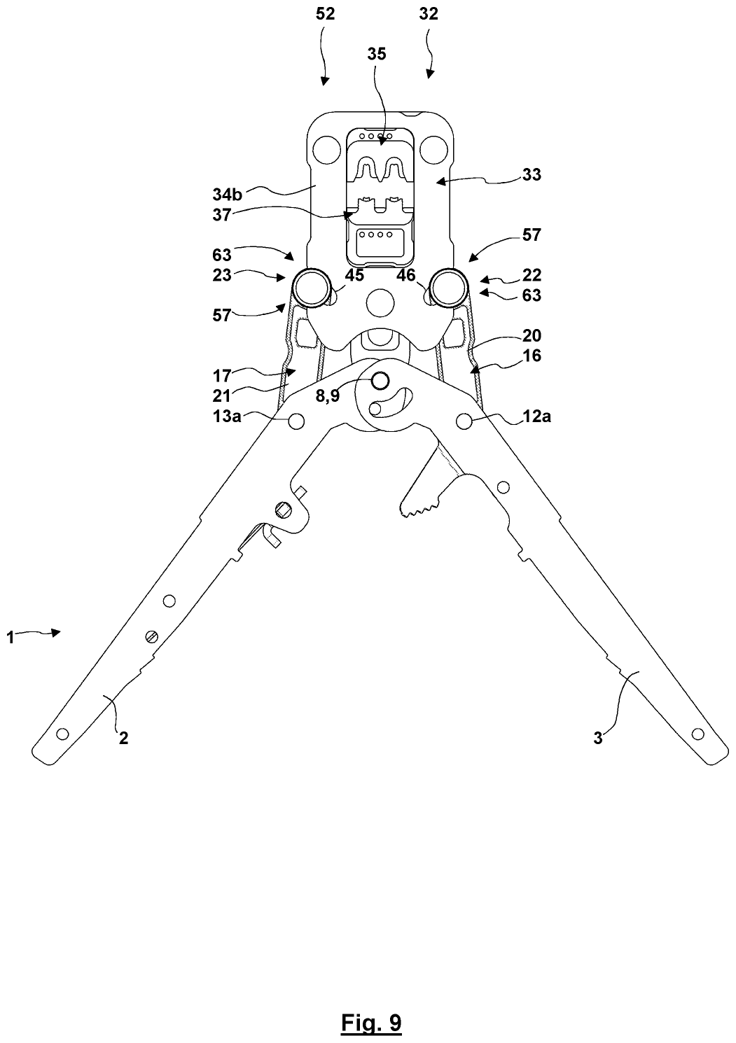

FIG. 9 shows the partially assembled state of the crimping pliers 52 at the time the coupling elements 22, 23 enter the coupling recesses 45, 46, with some parts of the crimping pliers 52 omitted here for better illustration.

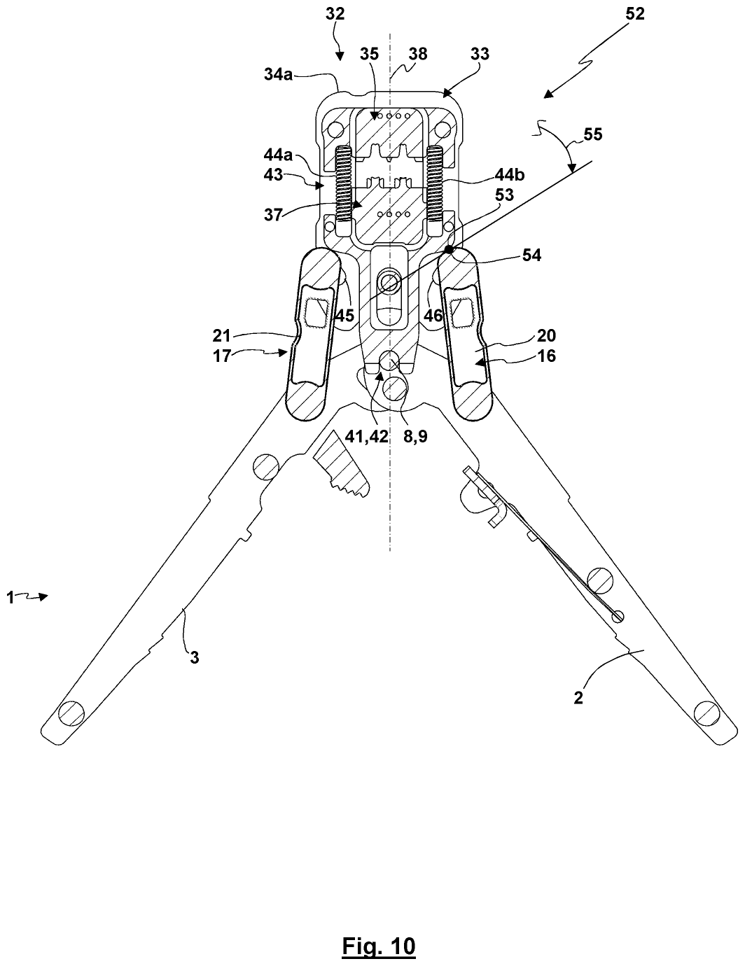

In a corresponding partial assembly position, FIG. 10 shows the crimping pliers 52 in a sectional view in the plane of the dies 35, 37 and in the plane of the crimping pliers head, in which the interaction of the pivot bolt 8 with the pivot bolt accommodation 41 and the contact force as a result of the springs 44a, 44b can be seen.

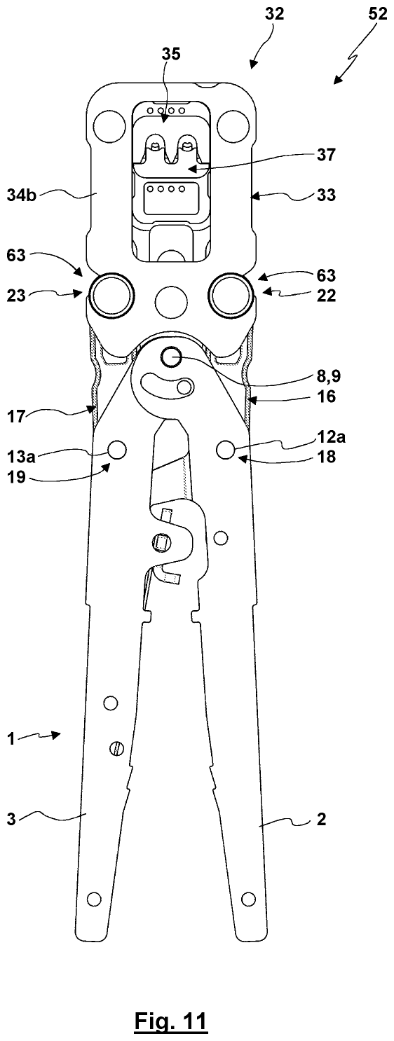

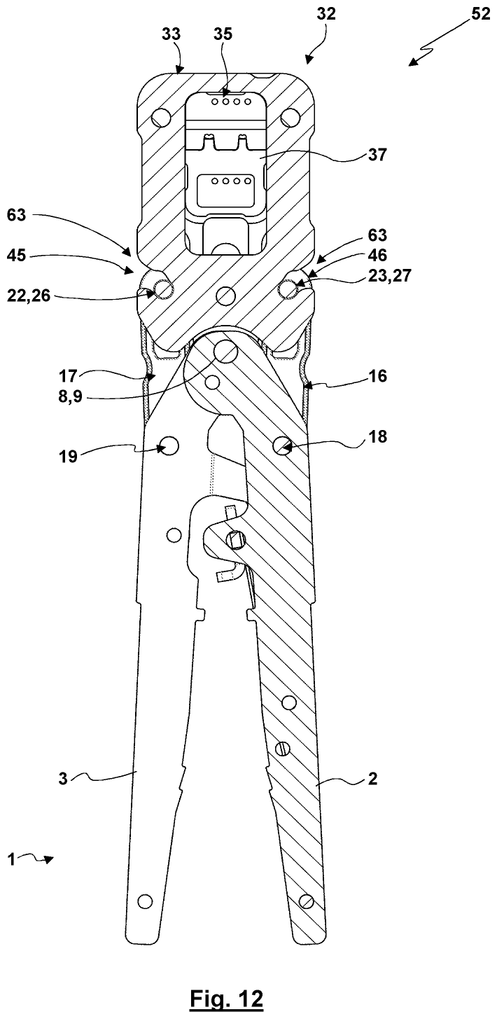

Finally, FIGS. 11 and 12 show illustrations corresponding to FIGS. 9 and 10, but here the crimping pliers 52 are shown in the closed position at the end of the crimping stroke.

As an optional feature, when the coupling elements 22, 23 enter the coupling recesses 45, 46 or even earlier when the pulling bars 16, 17 approach the pliers head frame 33, a contact surface 53 of the pulling bars 16, 17, 4 of the base body 20, 21 can come into contact with a contact surface 54 of the movable die half 37 (cp. FIG. 10). An actuating force applied to the pulling bars 16, 17, which pivots the pulling bars 16, 17 inward, is converted by the contact surfaces 53, 54 into an actuating force component that provides an assembly assistance force that strives to move the movable die half 37 in the closing direction and to compress the springs 44a, 44b. For this purpose, the contact surfaces 53, 54 are inclined at an acute angle 55 with respect to the crimping axis 38. During the insertion movement, the contact surfaces 53, 54 slide along each other. The contact surfaces 53, 54 can also be curved as desired, resulting in an angle 55 that varies during the insertion movement.

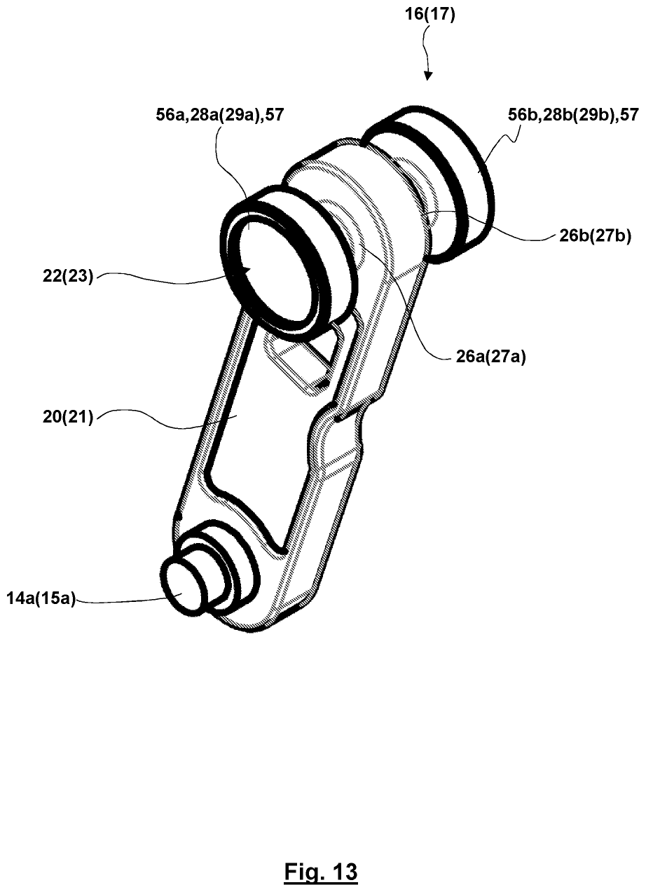

FIG. 13 is a three-dimensional single component drawing of a pulling bar 16, 17, which forms the base body 20, 21, the pivot pins 14a, 14b, 15a, 15b and the coupling elements 22, 23 as an integral, one-piece component. It can be seen here that the extensions 28, 29 are formed as disc bodies 56. It is possible that the extensions 28, 29 or disc bodies 56 form actuating elements 57 which simplify assembly and disassembly by providing that actuating forces required for assembly and disassembly and movement of the pulling bars 16, 17 can be applied to them by the user.

The coupling recesses 45, 46 can be of any shape. They do not have to be formed as an elongate hole 49. Rather, it is crucial that the coupling recesses 45, 46 form upwardly oriented hooks or suspension eyes in which the coupling elements 22, 23 can be suspended.

The embodiment according to FIGS. 1 to 13 represents a possible embodiment of the above “first variant”.

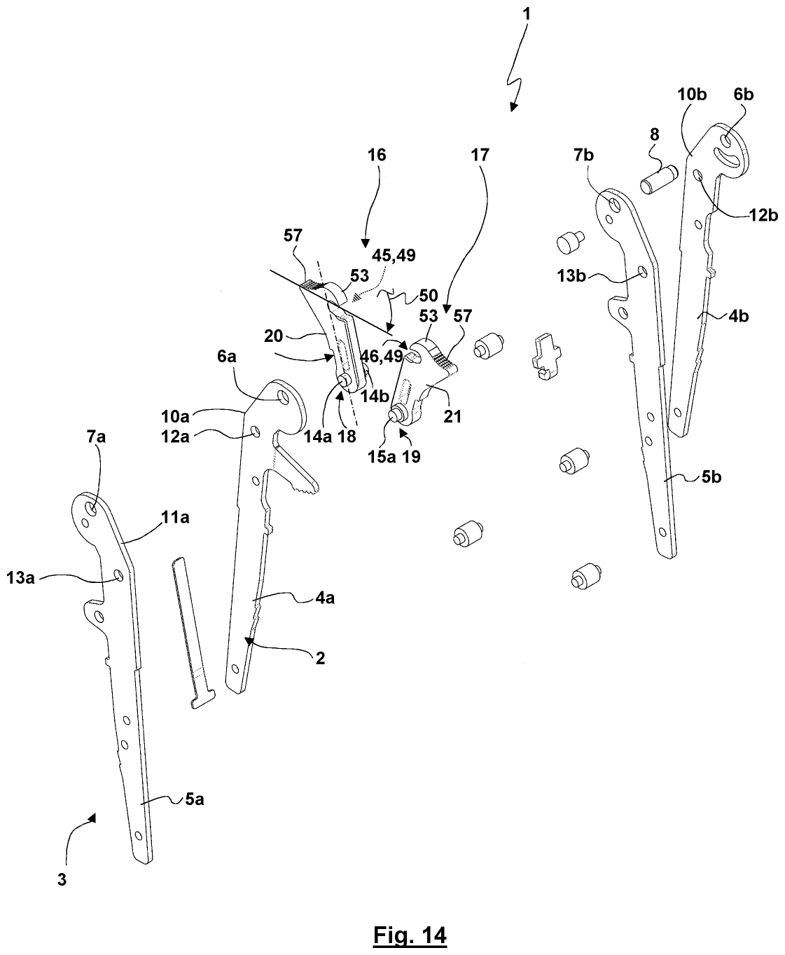

In FIGS. 14 to 21, a further embodiment of the crimping pliers actuation assembly group 1, the crimping pliers head 32 and the crimping pliers 52 formed with the crimping pliers actuation assembly group 1 and the crimping pliers head 32 is shown, which represents a possible embodiment of the above “second variant”. Here, the same reference numbers are used for structurally or functionally corresponding or similar components and features as in FIGS. 1 to 13, and reference is made to the description thereof.

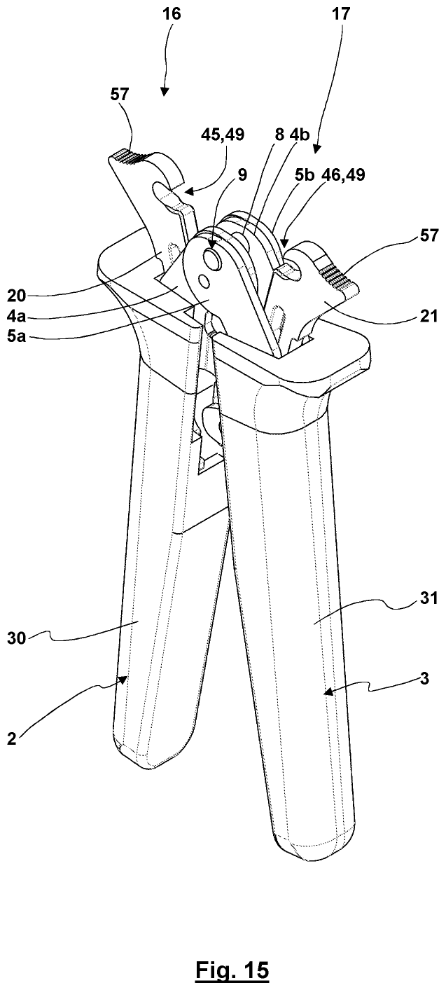

The crimping pliers actuation assembly group 1 shown in FIGS. 14 and 15 has pulling bars 16, 17 that do not have coupling elements 22, 23 embodied as coupling pins 26, 27. Instead, for this embodiment, the pulling bars 16, 17 comprise coupling recesses 45, 46, which are formed here as an elongated hole 49 open on one side. In this case, the coupling recesses 45, 46 are inclined at an acute angle 50 with respect to a radial direction to the pivot axis of the pivot bearings 18, 19 through the bottom of the coupling recess 45, 46, the acute angle preferably being in the range of 30° to 85° or 40° to 80° or 50° to 80°. As can be seen, in this case the base body 20, 21 of the pulling bars 16, 17 has lateral protrusions forming the actuating elements 57. Otherwise, the crimping pliers actuation assembly group 1 is designed in accordance with the crimping pliers actuation assembly group 1 shown in FIGS. 1 and 2 and described with respect thereto.

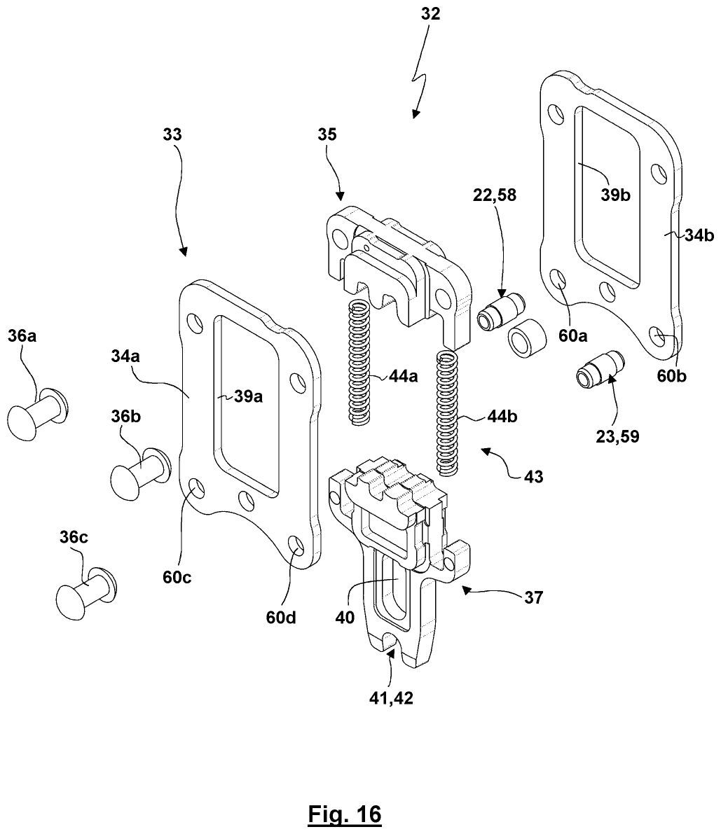

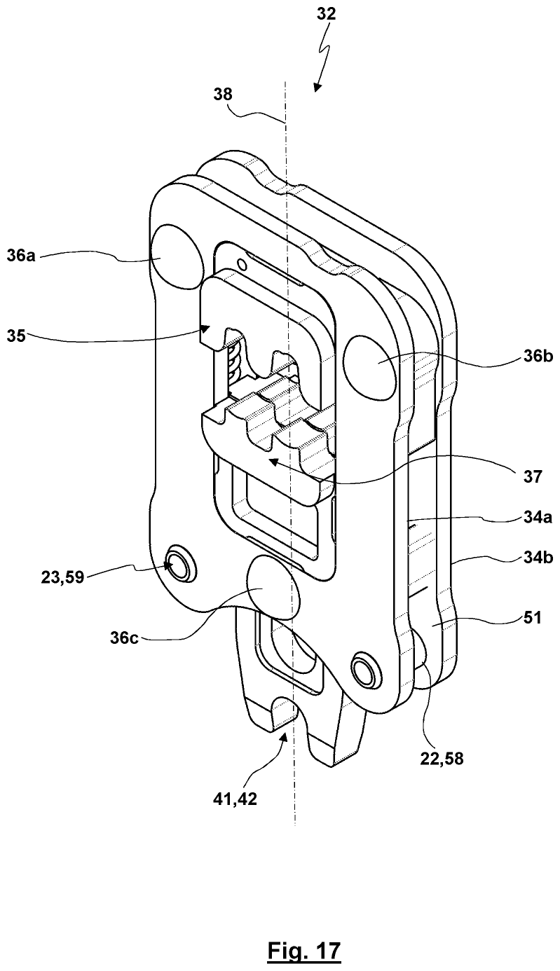

FIGS. 16 and 17 show the crimping pliers head 32 for this embodiment. Here, the pliers head frame 33 does not have coupling recesses 45, 46. Instead, the pliers head frame 33 has coupling elements 22, 23 in the lower end region facing the crimping pliers actuation assembly group 1 in the assembled state, which are formed as coupling bolts 58, 59. Preferably, the coupling bolts 58, 59 are multifunctional, in that they serve on the one hand as coupling elements for a coupling with the crimping pliers actuation assembly group 1 and on the other hand serve for a connection to the frame plates 34a, 34b. For the embodiment shown, the coupling bolts 58, 59 are stepped in the two end regions and are accommodated in a precisely fitting manner in corresponding accommodations 60a, 60b, 60c, 60d of the frame plates 34a, 34b, which are designed here as bores.

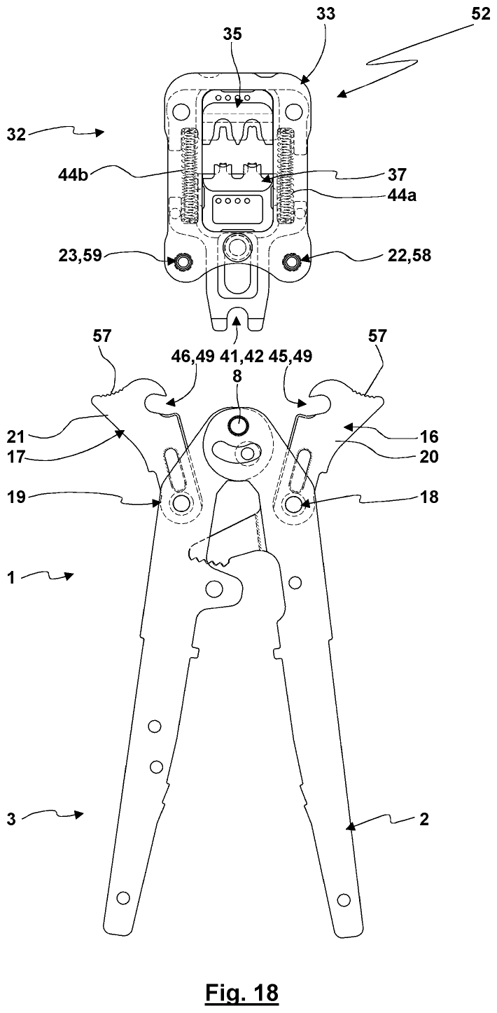

FIGS. 18 to 21 show the crimping pliers 52 formed with the crimping pliers head 32 and the crimping pliers actuation assembly group 1 in various states of assembly:

According to FIG. 18, the crimping pliers head 32 is disassembled from crimping pliers actuation assembly group 1. The pivot bolt accommodation 41 of the crimping pliers head 32 is freely accessible on the side facing the crimping pliers actuation assembly group 1. The pivot bolt 8 and the pulling bars 16, 17 of the crimping pliers actuation assembly group 1 are also freely accessible on the side facing towards the crimping pliers head 32. The pulling bars 16, 17 can be pivoted freely in the plane of the crimping pliers head.

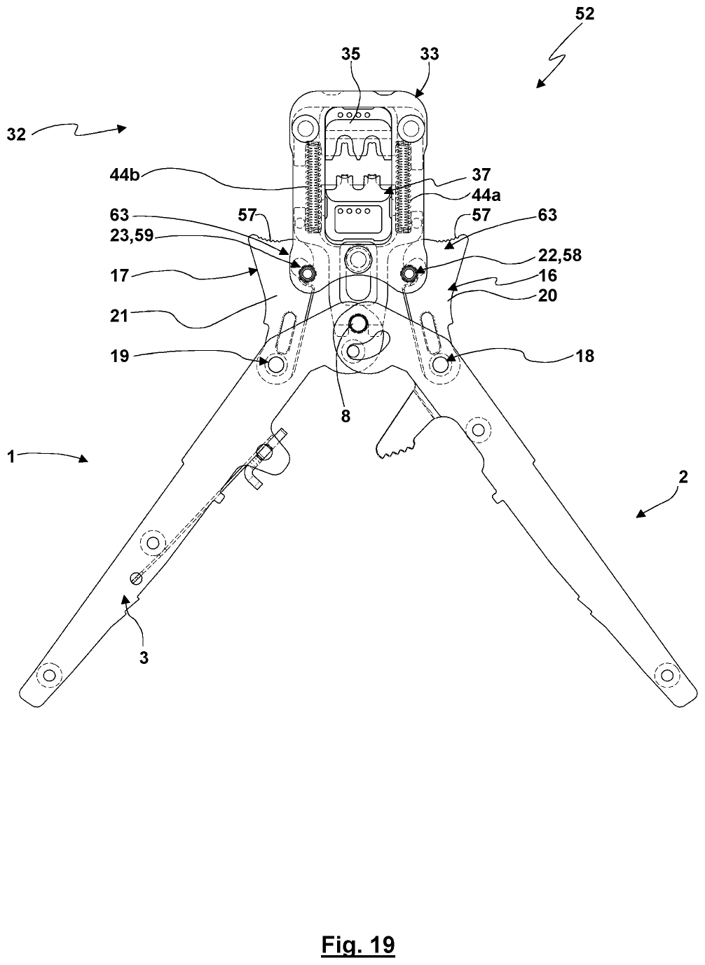

According to FIG. 19, the crimping pliers actuation assembly group 1 has been approached to the crimping pliers head 32 in such a way that the pivot bolt 8 enters the pivot bolt accommodation 41 and comes to rest against the bottom of the pivot bolt accommodation 41. In addition, the pulling bars 16, 17 are pivoted inwards, whereby the coupling bolts 58, 59 of the crimping pliers head 32 enter the coupling recesses 45, 46 of the pulling bars 16, 17. The length of the pulling bars 16, 17 is dimensioned in such a way that this entry is only possible when the movable die half 37 moves in the closing direction under the bias by the spring device 43. With regard to the extent of the closing movement and the force conditions what has been said with regard to the first embodiment applies accordingly.

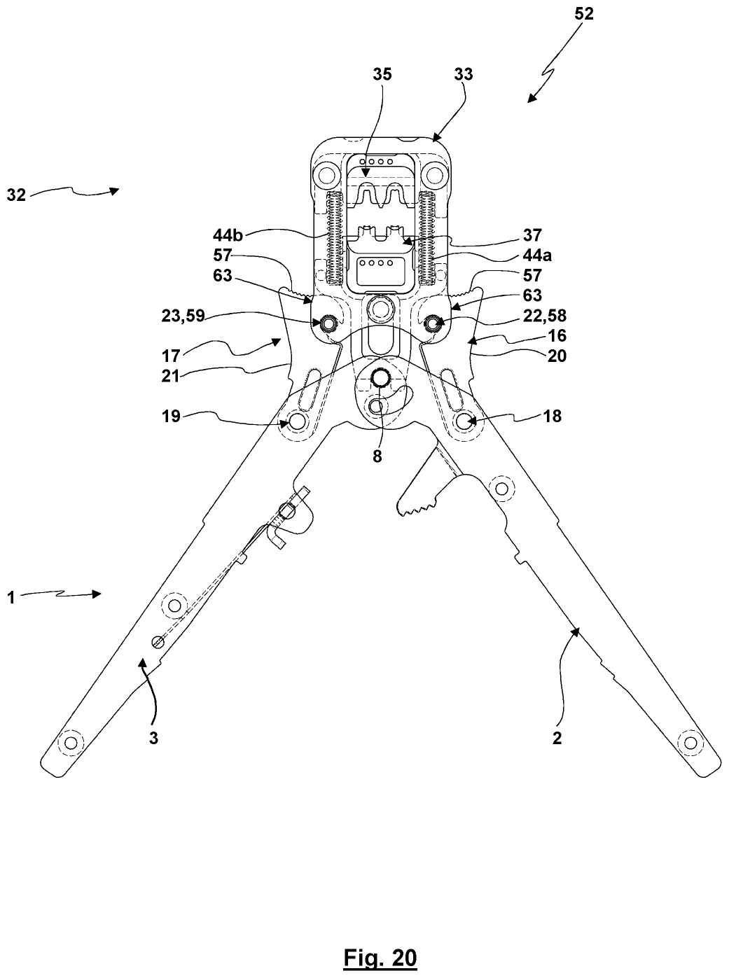

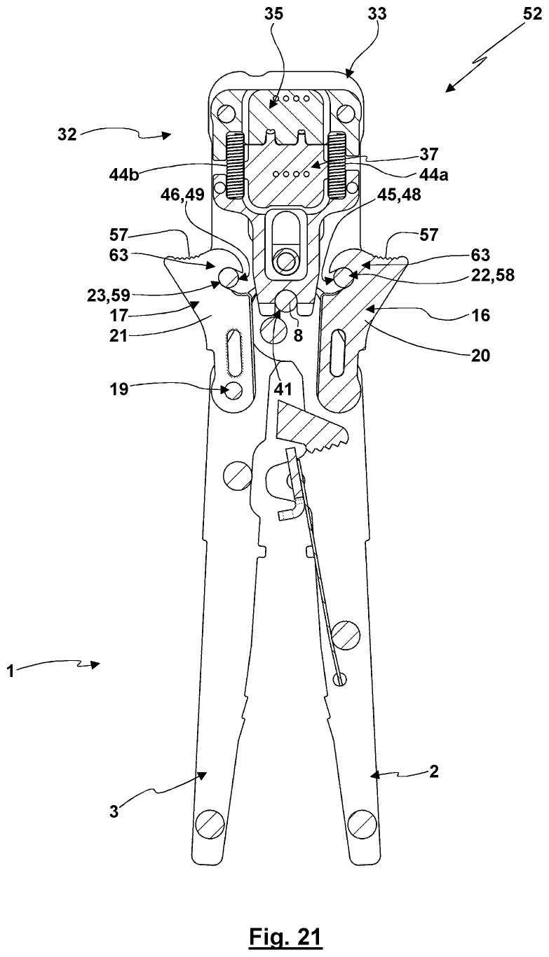

If the coupling bolts 58, 59 contact the bottom of the coupling recesses 45, 46 in the fully assembled position as shown in FIG. 20, the spring device 43 secures the state assembled in this way. The pivoting of the hand levers 2, 3 towards each other then leads to the passage of the crimping stroke until the closed position shown in FIG. 21 is reached.

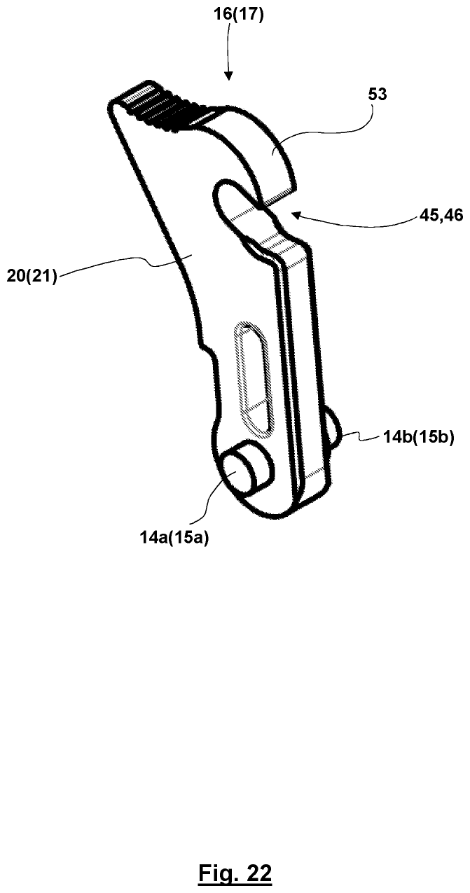

FIG. 22 shows the pulling bars 16, 17 as individual parts. The pulling bars 16, 17 are preferably formed in one piece with the base body 20, 21 and the pivot pins 14, 15 as well as the actuating element 57. Preferably, the pulling bars 16, 17 are produced in a MIN manufacturing process.

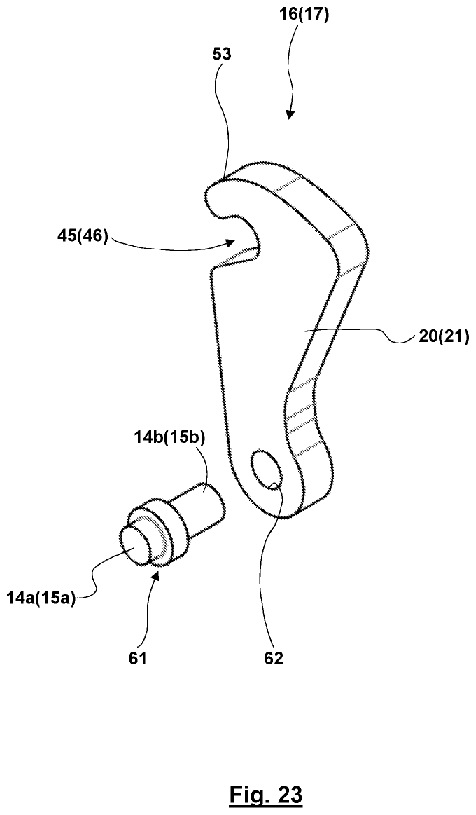

FIG. 23 shows an alternative design of the pulling bars 16, 17, wherein the base bodies 20, 21 and a pivot bolt 61 which forms the pivot pins 14, 15 are formed separately from one another. In this case, the base body 20, 21 can be manufactured, for example, as a milled or stamped part. The base body 20, 21 then has a bore 62 in which the pivot bolt 61 is accommodated with a fit, for example by means of a press fit.

Also for this embodiment, the pulling bars 16, 17 may have a contact surface 53 that comes into contact with a contact surface 54 of the movable die half 53 when the pulling bars 16, 17 are pivoted inward. The contact surface may generate an actuation force component that causes the movable die half 37 to move in the closing direction to allow the coupling bolts 58, 59 to enter the coupling recesses 45, 46.

The coupling recesses 45, 46 and the coupling elements 22, 23 form coupling devices 63 by means of which the crimping pliers head 32 can be assembled with and disassembled from the crimping pliers actuation assembly group 1 (in particular without the use of any tool).

Many variations and modifications may be made to the preferred embodiments of the invention without departing substantially from the spirit and principles of the invention. All such modifications and variations are intended to be included herein within the scope of the present invention, as defined by the following claims.

We claim:

1. Crimping pliers comprising
a) two hand levers,
b) a pivot bolt via which the hand levers are pivotably connected to one another,
c) two pulling bars linked to the hand levers at a distance from the pivot bolt,
d) a crimping pliers head with
da) a pliers head frame,
db) a spring device and
dc) a die half, which
is guided displaceably in a direction of a crimping axis on the pliers head frame,
is supported by the spring device on the pliers head frame in such a way that the spring device biases the die half in an opening direction, and
has a pivot bolt accommodation which is open on one side,
e) the pulling bars being connected to the pliers head frame via coupling devices, the pivot bolt being arranged in the pivot bolt accommodation, a pivoting of the hand levers causing a relative movement of the die half with respect to the pliers head frame, and a movement of the die half and a pivoting of the hand levers taking place in a pliers head plane,
f) the coupling devices each comprising a coupling recess open on one side and a coupling element, wherein the coupling between the coupling recess and the coupling element
fa) is established by means of a pivoting movement of the pulling bar in the pliers head plane and by means of an entry of the coupling element into the coupling recess brought about by this pivoting movement, and
fb) is secured by the spring device.

2. The crimping pliers of claim 1, wherein the coupling recesses define entry directions of the coupling elements into the coupling recesses, the entry directions being inclined at an acute angle with respect to the crimping axis.

3. The crimping pliers of claim 2, wherein
a) the coupling recesses are formed by the pliers head frame and/or
b) the coupling elements are coupling bolts, coupling pins or coupling protrusions of the pulling bars.

4. The crimping pliers of claim 3, wherein
a) the pliers head frame comprises two frame plates extending parallel to each other and each having a coupling part recess, and
b) a pulling bar has a base body and aligned coupling bolts, coupling pins or coupling protrusions arranged on both sides of the base body,
c) the base body extending into an interspace between the frame plates and the coupling bolts, coupling pins or coupling protrusions being arranged in the coupling part recesses.

5. The crimping pliers of claim 4, wherein the base body and the coupling bolts, coupling pins or coupling protrusions form one-piece pulling bars, which are in particular produced in a MIM manufacturing process.

6. The crimping pliers of claim 5, wherein the one-piece pulling bars have been manufactured in a MIM manufacturing process.

7. The crimping pliers of claim 4, wherein coupling bolts, coupling pins or coupling protrusions comprise end-sided extensions and the frame plates are each trapped in a direction vertical to the pliers head plane between one extension and the base body.

8. The crimping pliers of claim 2, wherein
a) the coupling recesses are formed by the pulling bars and/or
b) the coupling elements are coupling bolts, coupling pins or coupling protrusions formed by the pliers head frame or supported by the pliers head frame.

9. The crimping pliers of claim 8, wherein
a) the pliers head frame comprises two frame plates extending parallel to each other and connected to each other via a coupling bolt, and
b) a pulling bar has a base body which forms the coupling recesses and extends into an interspace between the frame plates,
c) the coupling bolt connecting the frame plates being arranged in the coupling part recesses.

10. The crimping pliers of claim 1, wherein the pulling bars comprise actuating elements protruding laterally or horizontally out of the pliers head frame.

11. The crimping pliers of claim 1, wherein the pulling bars and the movable die half comprise contact surfaces which convert assembly forces applied to the pulling bars into a force component which results in an increase of a bias of the spring device and a movement of the movable die half in a closing direction.

12. The crimping pliers of claim 2, wherein the pulling bars and the movable die half comprise contact surfaces which convert assembly forces applied to the pulling bars into a force component which results in an increase of a bias of the spring device and a movement of the movable die half in a closing direction.

13. The crimping pliers of claim 1, wherein in end regions facing away from the crimping pliers head the pulling bars comprise protrusions or pivot pins which are rotatably accommodated in bores of parallel hand levers plates of the hand levers.

14. A method for assembling crimping pliers with
a) two hand levers,
b) a pivot bolt by which the hand levers are pivotably connected to each other,
c) two pulling bars linked to the hand levers at a distance from the pivot bolt,
d) a crimping pliers head with
da) a pliers head frame,
db) a spring device and
dc) a die half, which
is guided displaceably in a direction of a crimping axis on the pliers head frame,
is supported by the spring means on the pliers head frame in such a way that the spring device biases the die half in an opening direction, and
comprises a pivot bolt accommodation being open on one side,
e) the pulling bars being connected to the pliers head frame via a coupling device, the pivot bolt being arranged in the pivot bolt accommodation and a pivoting of the hand levers in a closing direction causing a relative movement of the die half with respect to the pliers head frame in closing direction and
f) the coupling devices each comprising a coupling recess being open on one side and a coupling element, the coupling element being inserted into the coupling recess and being secured by the spring device against exiting from the coupling recess,
with the following method steps:
inserting the pivot bolt into the pivot bolt accommodation of the die half and
connecting the pulling bars to the crimping pliers head by entering of the coupling elements into the coupling recesses with simultaneous compression of the spring device in such a way that as a result of the bias by the spring device the coupling elements are secured against exiting from the coupling recesses.
